(19) United States
(12) Patent Application Publication
(10) Pub. No.: US 2006/0103119 A1
(43) Pub. Date: May 18, 2006

(54) Airbag apparatus

(75) Inventors: Takeshi Kurimoto, Echi-gun (JP); Akifumi Takedomi, Higashiomi-shi (JP); Kenji Hiraoka, Hiroshima-shi (JP)

Correspondence Address: KANESAKA BERNER AND PARTNERS LLP, SUITE 300, 1700 DIAGONAL RD, ALEXANDRIA, VA, 22314-2848, US

(73) Assignee: TAKATA CORPORATION, Tokyo (JP)

(21) Appl. No.: 11/263,945

(22) Filed: Nov. 2, 2005

(30) Foreign Application Priority Data
Nov. 16, 2004 (JP) 2004-331933

(51) Int. Cl. B60R 21/16

(52) U.S. Cl. 280/730.2; 280/729; 280/743.1

(57) ABSTRACT

In order to provide an airbag apparatus which can ensure protection of head and chest regions of a vehicle passenger in case of vehicle accident, the airbag apparatus includes head and chest chambers. The thickness of the head chamber in a deployed and inflated airbag in the lateral direction becomes larger than the thickness of the chest chamber in the lateral direction.

### BACKGROUND OF THE INVENTION AND RELATED ART STATEMENT

The present invention relates to an airbag apparatus for a vehicle such as an automotive vehicle and more specifically to an airbag apparatus which is deployed and inflated in a passenger protection zone between a vehicle passenger and a vehicle side wall portion, for protecting the head and chest portions of the vehicle passenger in case of vehicle accident such as a side collision or rollover of the vehicle.

Various types of airbag apparatus have been proposed for protecting the head and chest portions of a vehicle passenger from impact against or being impacted by a vehicle side wall portion such as a side window or a door in case of vehicle accident such as side collision or rollover of a vehicle. For example, Japanese Unexamined Patent Application Publication No. 10-297409 discloses an airbag apparatus provided with two internal spaces, that is, a lower space or chamber for protecting the chest/upper body of the vehicle passenger and an upper chamber which is communicated with the lower chamber for protecting the head of the vehicle passenger. The airbag apparatus disclosed in this Japanese Unexamined Patent Application Publication is configured in such a manner that the airbag is deployed and inflated entirely by supplying gas from an inflator upon occurrence of vehicle accident, first to the lower chamber, and after flowing into the lower chamber, the gas is then supplied into the upper chamber.

In the airbag apparatus of this type intended for protecting the head portion and the chest portion of the vehicle passenger in case of vehicle accident, it is highly desirable to ensure protection of the vehicle passenger by deploying and inflating the airbag in an optimal manner corresponding to the respective portions of the vehicle passenger which require protection.

In view of this, it is an object of the present invention to provide an airbag apparatus development technique and arrangement which can ensure protection of the head portion and the chest portion of the vehicle passenger in case of vehicle accident.

Further objects and advantages of the invention will be apparent from the following description of the invention.

### SUMMARY OF THE INVENTION

The embodiments of the present invention are directed to provide effective protection of at least the head and chest portions of the vehicle passenger, in various types of vehicles, more typically in automotive vehicles.

A first aspect of the present invention resides in an airbag apparatus which includes at least an airbag and a gas supply device. The airbag is configured to be deployed and inflated into a passenger protection zone between a vehicle passenger and a side of the vehicle in the case of vehicle accident such as a side collision or vehicle rollover. Gas for deployment and inflation is supplied to the airbag via the gas supply device/means having a gas generating function. The term “vehicle side wall portion” in this specification encompasses a vehicle structure such as the (right or left) sides of the vehicle passenger, and typically, the vehicle side wall portion is constituted by a side window, pillar, a door trim or the like.

In particular, the airbag according to the embodiments of the present invention includes at least a head chamber for protecting the head portion of the vehicle passenger, and a chest chamber for protecting the chest of the vehicle passenger. The respective chambers are formed into compartments defined by partitioning an internal space in the airbag. The present invention includes a structure in which only the space areas of the head chamber and the chest chamber are formed in the airbag, or a structure in which a space area other than the head chamber and the chest chamber is formed in the airbag in addition to the head chamber and the chest chamber.

The airbag is configured in such a manner that a width of the head chamber in the lateral direction of the vehicle, is larger than the width of the chest chamber in the lateral direction at a time of deployment and inflation. The thickness/width of the respective chambers is defined as a length of the chamber disposed in a passenger protection area between the vehicle passenger and the vehicle side wall portion in the lateral direction. The term “the lateral direction” in the present invention corresponds to a normal vector direction of a passenger protection surface of the airbag facing the vehicle passenger in a deployed and inflated state. The term “at the time of deployment and inflation” in the present invention includes timing from a beginning of deployment and inflation process upon completion of inflation when the passenger is constrained.

In this arrangement, the head portion of the vehicle passenger is protected by the head chamber which is relatively large in thickness with respect to the respective portions of the airbag at the time of deployment and inflation, and the chest portion of the vehicle passenger is protected by the chest chamber which is relatively smaller in thickness at the time of deployment and inflation. Accordingly, the airbag can be deployed and inflated in an optimal mode corresponding to the respective portions to be protected of the vehicle passenger, whereby protection of the vehicle passenger can be ensured.

A second aspect of the present invention resides in an airbag wherein a seam in which the wall surfaces of airbag panels opposing each other are directly stitched together in at least one of the head chamber and the chest chamber. Then, the thickness of the chambers in the lateral direction at the time of deployment and inflation is adjusted by the stitching at the seam. This structure includes a feature in which the relative thickness of the chambers is adjusted by the stitching at the seam in either one of the head chamber or the chest chamber, and a feature in which the relative thickness of the chambers is adjusted by the stitching of the seam in both of the head chamber and the chest chamber.

In this arrangement, since the thicknesses of the chambers in the lateral direction of the head chamber and the chest chamber are adjusted by the stitching at the seam, an adjustment structure of the thickness of the chambers is simplified.

A third aspect of the invention resides in the an airbag wherein a gas sealing agent is applied on the inner wall surfaces for restricting gas in the head chamber from flowing out of the chamber. A typical application mode of the “gas sealing agent” in this specification includes, with regard to the head chamber, a first arrangement in which a coating layer is formed entirely on the inner wall surfaces of the airbag panels, a second arrangement in which the sealing agent is applied along the seam in which the airbag panels are stitched together, and a third arrangement in which the first arrangement and the second arrangement are combined.

Transmission of gas through the airbag panels is prevented by the first arrangement, and transmission of gas through the seam between the airbag panels is prevented by the second arrangement, and in particular, the both of the transmission of gas through the airbag panels themselves and the transmission of gas through the seam are prevented by the third arrangement, whereby improvement of air-tightness is achieved with higher effectiveness by the cooperation of these arrangements.

In this arrangement, by enhancing the air-tightness specifically in the head chamber out of the respective portions of the airbag by the use of the gas sealing agent, a high-pressure state in the head chamber after having deployed and inflated can be maintained, and particularly protection of the head portion of the vehicle passenger is ensured.

A fourth aspect of the present invention resides in an airbag which is provided with a vent hole formed on the airbag panel for allowing gas in the chest chamber to be discharged out of the chamber. Therefore, the gas flowing into the chest chamber at the time of deployment and inflation of the airbag is discharged through this vent hole. The size of the vent hole is determined as needed based on the desired mode of deployment and inflation of the chest chamber, for example, the period of gas retention or the gas pressure.

In this arrangement, the vent hole can prevent the internal pressure in the chest chamber from being excessively increased or the high-pressure state in the chest chamber from being excessively and continuously maintained, whereby particularly protection of the chest portion of the vehicle passenger is ensured.

As described above, according to the exemplary embodiments of the present invention, with the configuration such that the thickness of the head chamber in the lateral direction of the deployed and inflated airbag is larger than the thickness of the chest chamber in the lateral direction in case of vehicle accident, the airbag can be deployed and inflated optimally corresponding to the respective portion of the vehicle passenger to be protected, whereby the overall protection of the vehicle passenger in case of the vehicle accident is promoted.

### BRIEF DESCRIPTION OF THE DRAWINGS

FIG. 1 is a side view showing a structure of a deployed airbag apparatus according to the present embodiment.

FIG. 2 is an enlarged perspective view showing a gas supply device used in the arrangement depicted in FIG. 1.

FIG. 3 is a side view of the airbag deployed and inflated for a vehicle passenger C seated on a driver's seat S.

FIG. 4 is a front view of the airbag deployed and inflated for the vehicle passenger C seated on the driver's seat S.

### DETAILED DESCRIPTION OF PREFERRED EMBODIMENTS

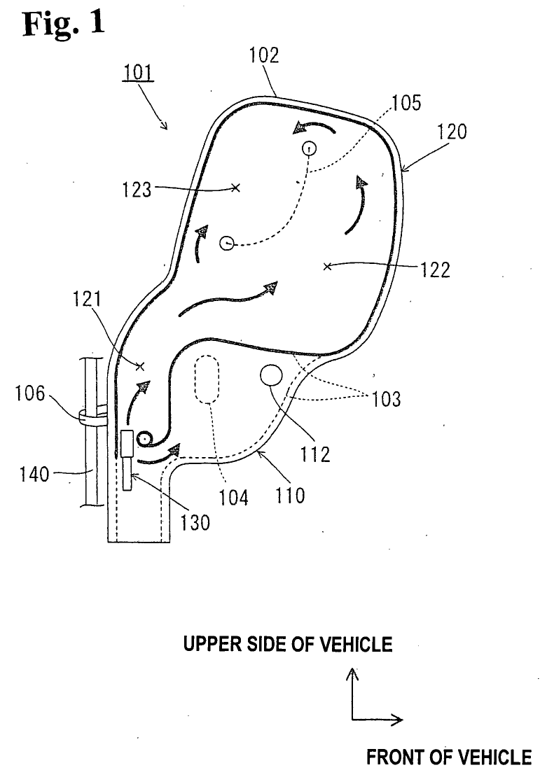

Referring now to FIG. 1 to FIG. 4, an airbag apparatus 101 according to an embodiment of the “airbag apparatus” of the present invention will be described. The airbag apparatus 101 according to the illustrated embodiment is configured for disposition with respect to a driver's seat in a motor vehicle having a steering wheel on the right hand side of the vehicle.

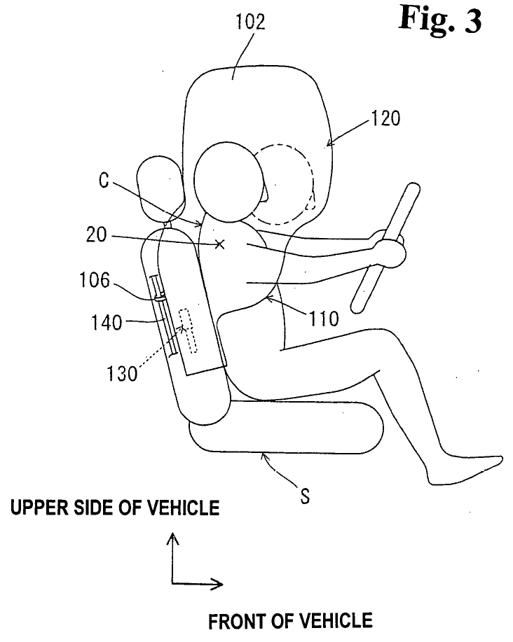

FIG. 1 is a drawing showing a structure of the airbag apparatus 101 according to the present embodiment, wherein the airbag 102 is fully deployed. As shown in FIG. 1, the airbag apparatus 101 is composed essentially of the airbag 102 and a gas supply device 130. In the present embodiment, the airbag apparatus 101 is disposed in a side portion of a passenger seat (a driver's seat S in FIG. 3). In FIG. 1, the airbag 102 is arranged so that the right side (as seen in the drawing) is directed toward the front of the vehicle and the upper side (as seen in the drawing) is directed upwardly with respect to the vehicle.

The airbag 102 includes a chest chamber 110 disposed on a lower side of the vehicle so as to protect a chest/upper torso region of the vehicle passenger, and a head chamber 120 disposed on the upper side of the vehicle so as to protect the head of the vehicle passenger.

The chest chamber 110 and the head chamber 120 are formed by partitioning parts of the airbag. In one embodiment, this partitioning is achieved by stitching wall surfaces of opposing airbag panels directly together in a manner which forms seams 103. In the present embodiment, the capacity (volume) of the head chamber 120 is relatively larger than the capacity of the chest chamber 110.

The thick solid line shown in the drawing, depicts portions of the seams 103 wherein a gas sealing agent is applied. This sealing agent can be for example, a silicon based sealing agent which functions to prevent transfer of gas between an interior and an exterior of the head chamber 120 and enhance the air-tightness of the head chamber 120.

A coating layer is formed at least on the entire surface of an inner wall surface of the head chamber 120 among the respective chambers, and the coating layer functions to prevent escape of gas from the interior of the head chamber 120 and to enhance its gas air-tightness.

In this manner, in the head chamber 120 of the present embodiment, since transmission of gas through the seams 103 between the airbag panels is prevented by the gas sealing agent, and the transmission of gas through the airbag panels themselves is prevented by the coating layer, the net effect provides improvement in air-tightness and attendant higher effectiveness.

The airbag 102 is stored in the airbag apparatus 101 built in the seat side portion in a folded state (such as in an accordion-like folded state).

In the chest chamber 110, stitching is carried out to form a seam 104 which is configured so that a thickness of the chamber in the lateral direction (of the vehicle) at the time of deployment and inflation becomes the desired thickness (a chamber thickness d1 described later). In other words, the thickness of the chest chamber 110 in the lateral direction (of the vehicle) at the time of deployment and inflation is adjusted by the manner in which the seam 104 is stitched and the resulting manner in which the wall surfaces of the opposing airbag panels are directly connected together.

The lateral direction of the chest chamber 110 corresponds to a normal vector direction of a passenger protection surface of the chest chamber 110 which faces the chest portion of the vehicle passenger in the deployed and inflated state.

The airbag panel of the chest chamber 110 is formed with a vent hole 112 which allows gas to discharge from chest chamber 110. The diameter (size) of the vent hole 112 is set as needed based on a desired deployment and inflation characteristics of the chest chamber (such as a period of gas retention or a gas pressure) 110.

The head chamber 120 is provided with a first compartment 121, a second compartment 122, a third compartment 123 which are arranged to be sequentially inflated.

The first compartment 121 constitutes a gas flow path zone for introducing gas into the head chamber 120. The first compartment 121 is disposed below the second compartment 122 and the third compartment 123 at the time of deployment and inflation, and is also formed into a substantially cylindrical-shape member which extends longitudinally in the vertical direction.

The first compartment 121 in this structure functions to support the second compartment 122 and the third compartment 123 firmly from below, whereby an upright posture of the entire head chamber 120 is ensured at the time of deployment and inflation.

The second compartment 122 and the third compartment 123 are deployed and inflated by gas introduced through the first compartment 121, and constitute a protection area for protecting the head of the vehicle passenger. The second compartment 122 and the third compartment 123 constitute a portion for achieving the substantial protective function for the head of the vehicle passenger immediately after the occurrence of an accident.

There may be a case where either one of the second compartment 122 or the third compartment 123 provides substantially all of the protective for the occupant's head or a case where both of the second compartment 122 and the third compartment 123 provide the substantial protective function for the occupant's head depending on the seated position of the vehicle occupant or the state of collision (e.g. an oblique collision or the like). The second compartment 122 constitutes a space area lager than the third compartment 123 in terms of capacity, and the second compartment 122 is configured to be increased in pressure earlier than in the third compartment 123 since gas for deployment and inflation passed through the first compartment 121 flows directly into the second compartment 122.

In other words, the period required for increasing an internal pressure to a predetermined high pressure is shorter for the second compartment 122 than for the third compartment 123, and hence a building-up capability is enhanced in the second compartment 122. The second compartment 122 and the third compartment 123 are partitioned from each other by stitching the airbag panels together at a portion corresponding to the head chamber 120 at a seam 105.

The head chamber 120 is adapted in such a manner that the chamber thickness in the lateral direction at a portion corresponding to the second compartment 122 and the third compartment 123 at the time of deployment and inflation becomes a desired thickness (chamber thickness d2 described later). The lateral direction of the head chamber 120 corresponds to a normal vector direction of a passenger protection surface of the head chamber 120 which faces the head portion of the vehicle passenger in the deployed and inflated state.

A strap 106 which functions as a connecting band is connected to the airbag 102 having the structure described above. This strap 106 encircles a supporting rod 140 which extends in the vertical direction of the vehicle. Accordingly, the airbag 102 and the supporting rod 140 are connected via the strap 106. The supporting rod 140 allows movement the airbag 102 in the vertical direction via the strap 106 and functions as a guide member which guides the airbag 102 upward at the time of deployment and inflation. The supporting rod 140 is fixed to a frame portion of a vehicle seat or a bolt portion of a retainer.

The gas supply device 130 has a structure which can generate gas for deployment and inflation and supply the gas to the inner space of the airbag 102. The gas supply device 130 is arranged in the airbag 102 longitudinally in the vertical direction near an inlet arrangement which communicates with both the head chamber 120 and the chest chamber 110.

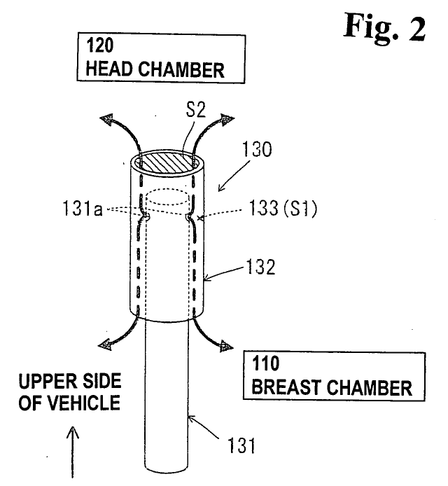

A perspective view of the structure of the gas supply device 130 is shown in FIG. 2. As shown in this figure, the gas supply device 130 includes a single inflator 131 and a flow directing cylindrical sleeve 132. The sleeve 132 is arranged so as to cover a gas discharge portion 131a of the inflator 131. Accordingly, an inner peripheral portion of the sleeve 132 and an outer peripheral portion of the inflator 131 form a space 133 therebetween which extends in the vertical direction.

In this arrangement, gas of a uniform pressure discharged sideward from the gas discharge portion (discharge holes) 131a of the inflator 131 is distributed simultaneously into the head chamber 120 on the upper side and the chest chamber 110 on the lower side. At this time, the gas discharged from the gas discharge portion 131a flows against the inner peripheral surface of the sleeve 132. Part of the gas flows upward in the space 133, and flows toward the head chamber 120. On the other hand, the remaining gas flows downward in the space 133 and flows toward the chest chamber 110 side. The sleeve 132 prevents generation of uneven gas flow by being affected by the deployment conditions of the airbag 102 (a folded state of the airbag, a mode of deployment of the cover, and so on) by forming the space 133 for allowing smooth gas flow between the sleeve 132 and the outer periphery of the inflator 131, thereby functioning to smooth the supply of gas to the respective chambers.

In the present embodiment, a cross sectional area S2 of a flow path through which the gas flows toward the head chamber 120 side may be formed to be larger than a cross sectional area (a cross sectional area S1 of the space 133) of a flow path through which the gas flows toward the chest chamber 110 side. Accordingly, resistance of the flow path of the gas directed to the head chamber 120 can be reduced, whereby a quantity of gas flow flowing into the head chamber 120 becomes larger than the quantity of gas flow flowing into the chest chamber 110. In this manner, the cross sectional area of the flow path through which the gas moves to the respective chambers can be set as desired by the sleeve 132, and hence the sleeve 132 functions to adjust the quantity of gas flow flowing into the respective chambers.

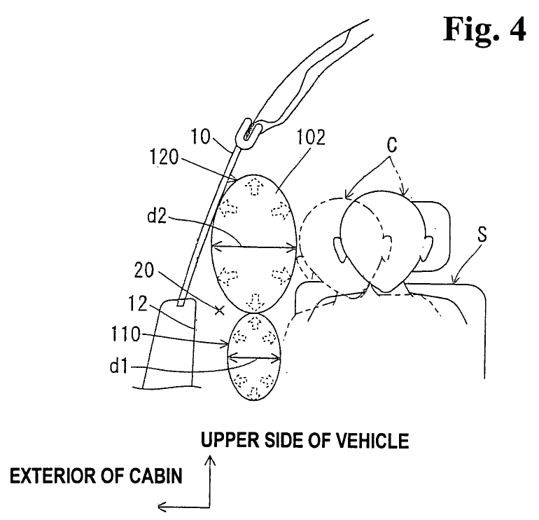

A state in which the airbag 102, described above, is deployed and inflated in case of vehicle accident, such as side collision or rollover of the vehicle, is shown in FIG. 3 and FIG. 4. FIG. 3 is a side view of the airbag 102 deployed and inflated for a vehicle passenger C seated on the driver's seat S, and FIG. 4 is a front view of the airbag 102 deployed and inflated for the vehicle passenger C seated on the driver's seat S.

When the side collision or rollover of the vehicle occurs, the gas supply device 130 is activated, and gas for deployment and inflation is generated from the inflator 131. The gas is distributed to the head chamber 120 and the chest chamber 110 by the distribution effect of the sleeve 132 and supplied in parallel. In other words, the gas discharged from the gas discharge portion 131a of the inflator 131 is supplied simultaneously to the head chamber 120 and the chest chamber 110 through separate routes. In association with this, the airbag 102 stored in the airbag apparatus 101 built in the driver's seat S in advance starts deployment and inflation action (action to be inflated while being deployed), and is deployed and inflated upward. At this time, the chest chamber 110 and the head chamber 120 of the airbag 102 are deployed and inflated respectively by gas flowing therein and the pressure therein is increased. At this time, when the passenger is constrained by the airbag 102, the airbag is inflated at least in such a manner that the chamber thickness d2 of the head chamber 120 in the lateral direction becomes larger than the chamber thickness d1 of the chest chamber 110 in the lateral direction.

The pressure in the chest chamber 110 is substantially uniformly increased in the entire chamber in a process of deployment and inflation. After the chest chamber 110 completes the deployment and inflation, the thickness of the chest chamber 110 in the lateral direction in FIG. 4 reaches the thickness d1 at least to constrain the passenger, and then the gas pressure in the chest chamber 110 is lowered by discharging the gas to the outside of the chest chamber 110 via the vent hole 112.

On the other hand, the head chamber 120 is deployed and inflated to increase in pressure from the first compartment 121 disposed at the entrance of the chamber, the second compartment 122 and third compartment 123 disposed on the upstream side thereof in sequence in the process of deployment and inflation thereof. At this time, the first compartment 121 is inflated into a substantially cylindrical shape extending longitudinally in the vertical direction, and hence supports the second compartment 122 and the third compartment 123 firmly from below.

Therefore, the upright posture of the entire head chamber 120 in the vertical direction is ensured. Then, the thickness of the head chamber 120 in the lateral direction in FIG. 4 with its deployment and inflation completed becomes the thickness d2 (>d1) at least when constraining the passenger. Then, since the period required for achieving the predetermined high pressure in the second compartment 122 is shorter than in the third compartment 123, the building-up capability of the second compartment 122 which achieves substantial protective functions of the head portion of the vehicle passenger C right after occurrence of accident is enhanced, and hence the second compartment 122 can be deployed and inflated quickly.

In this manner, the airbag 102 is deployed and inflated in the passenger protection area 20 on the side of the vehicle passenger C so as to protect at least the head portion and the chest portion of the vehicle passenger C as shown in FIG. 3 and FIG. 4. The passenger protection area 20 is a protection area or zone defined between the vehicle side wall portion composed of a side window 10 or a door trim 12 or the like and the vehicle passenger C, and corresponds to the “passenger protection area” in the present invention.

Then, the vehicle passenger C impacting with the airbag 102 with its deployment and inflation completed is constrained thereby. At this time, after the vehicle passenger C has impacted with the airbag 102 with its deployment and inflation completed, the head chamber 120 is maintained at a high-pressure state, which is higher than the pressure in the chest chamber 110. Also, the period in which the head chamber 120 is maintained in the high pressure state is longer than the period in which the chest chamber 110 is. This is because of the gas discharging effect of the vent hole 112 in the chest chamber 110 and the gas sealing effect of the gas sealing agent and the coating layer in the head chamber 120, since the entire head chamber 120 is partitioned in a state in which the air-tightness is enhanced by the gas sealing agent and the coating layer, and in addition, while the chest chamber 110 has the vent hole 112, the head chamber 120 does not have such a vent hole.

In the embodiments of present embodiment, since the quantity of gas flow flowing into the head chamber 120 is larger than the quantity of gas flow flowing into the chest chamber 110, at least upon completion of the deployment and inflation of the airbag 102, the pressure in the head chamber 120 is increased to a level higher than the pressure in the chest chamber 110.

In other words, in the embodiments of present embodiment, the sleeve 132 functions to prevent uneven generation of gas flow and smoothes the gas supply to the respective chambers, and also functions to distribute the gas for deployment and inflation more to the head chamber 120 than to the chest chamber 110, so as to increase the pressure in the head chamber 120 to the higher level than that in the chest chamber 110.

As described above, according to the present embodiment, with a configuration in which the thickness of the head chamber 120 in the lateral direction of the deployed and inflated airbag 102 becomes larger than the thickness of the chest chamber 110 in the lateral direction in case of occurrence of vehicle accident, the airbag 102 can be deployed and inflated in an optimal manner for the head portion and the chest portion of the vehicle passenger C for constraining the vehicle passenger 102. Accordingly, protection of at least the head portion and the chest portion of the vehicle passenger C is achieved.

According to the embodiment of the present embodiment, since the thickness of the chambers in the lateral direction at the time of deployment and inflation can be adjusted by the seam in which the wall surfaces of the opposing airbag panels are stitched together, the adjustment structure of the chamber thickness can be simplified.

According to the embodiment of the present embodiment, by enhancing the air-tightness specifically in the head chamber 120 out of the respective portions of the airbag 102 by the use of the gas sealing agent and the coating layer, the high-pressure state in the head chamber 120 after deployment and inflation can be maintained, whereby protection of, particularly, the head portion of the vehicle passenger is ensured.

According to the present embodiment, the vent hole 112 can prevent the internal pressure in the chest chamber 110 from excessively increased or the high-pressure state in the chest chamber 110 from being excessively and continuously maintained, whereby protection of, particularly, the chest portion of the vehicle passenger is ensured.

The present invention is not limited to the above-described embodiment, and various applications or modifications may be made without departing from the scope of the appended claims. For example, respective modes shown below in which the above described embodiment is applied may be implemented.

The above-described embodiment describes the structure of the chest chamber 110 of the airbag 102 in which the chamber thickness in the lateral direction at the time of deployment and inflation is adjusted by stitching at the seam 104 in which the wall surfaces of the opposing airbag panels are directly stitched together. However, the present invention may employ other structures as the structure for adjusting the thickness of the chambers. For example, the invention may be configured in such a manner that the wall surfaces of the opposing airbag panels are joined via another member (for example, a belt-shaped or cord shaped member) and the thickness of the chambers in the lateral direction at the time of deployment and inflation is adjusted by adjusting the length of the member.

The above-described embodiment describes the structure in which the chamber thickness in the lateral direction at the time of deployment and inflation is adjusted by stitching at the seam 104 in the chest chamber 110. However, in the present invention, it is advantageous that the airbag is configured in such a manner that the thickness of the head chamber 120 in the lateral direction is relatively larger than the thickness of the chest chamber 110 in the lateral direction at the time of deployment and inflation, and the positions to form the seams such as the seam 104 are not limited to the chest chamber 110. For example, the present invention includes the mode in which the thickness of the chambers is relatively adjusted by stitching at the seam in either one of the chest chamber 110 or the head chamber 120, or the mode in which the thickness of the chambers is relatively adjusted by stitching at the seam in both of the chest chamber 110 and the head chamber 120.

In the above described embodiment, the gas sealing agent and the coating layer for restricting the gas in the head chamber 120 from flowing outside of the chamber are applied on the inner wall surface of the airbag panel of the airbag 102, and the vent hole 112 for allowing the gas in the chest chamber 110 from to be discharged out from the chamber is provided. However, in the present invention, the gas sealing agent, the coating layer and the vent hole 112 may be omitted as preferred. In the present invention, regarding the application of the gas sealing agent in the head chamber 120, at least one of the gas sealing agent applied to the seam 103 between the airbag panels and the coating layer applied on the entire surface of the inner wall surface of the airbag panels may be omitted as needed.

Also, in the above-described embodiment an airbag apparatus 101 built into the passenger seat has been described. However, the airbag apparatus of the present invention may have a structure which is built into a portion other than the passenger seat, for example, the trim of the vehicle body, a pillar, a roof rail or the like.

In the above described embodiment, the airbag apparatus 101 is applied to a vehicle passenger seated in the driver's seat. However, the present invention may be applied to a vehicle passenger seated on other seat such as a passenger seat or a rear seat.

The disclosure of Japanese Patent Application No. 2004-331933 filed on Nov. 16, 2004 is incorporated herein.

While the invention has been explained with reference to the specific embodiments of the invention, the explanation is illustrative, and the invention is limited only by the appended claims.

What is claimed is:

1. An airbag apparatus comprising:
an airbag to be deployed and inflated in a passenger protection area between a vehicle passenger and a vehicle side wall portion in case of vehicle accident, said airbag having a head chamber for protecting a head of the vehicle passenger and a chest chamber for protecting a chest of the vehicle passenger, a thickness of the head chamber in a lateral direction of the vehicle being larger than a thickness of the chest chamber in the lateral direction at a time of deployment and inflation; and
a gas supply device for supplying gas for deployment and inflation of the airbag.

2. An airbag apparatus according to claim 1, wherein said airbag comprises opposing airbag panels, and a seam for directly stitching wall surfaces of the opposing airbag panels together for defining at least one of the head chamber and the chest chamber, said thickness of the chambers in the lateral direction at the time of deployment and inflation being determined by stitching at the seam.

3. An airbag apparatus according to claim 1, wherein the airbag has a gas sealing agent applied to an inner wall surface of the airbag panel for restricting gas release from the head chamber.

4. An airbag apparatus according to claim 1, wherein the airbag is provided with a vent hole formed in an airbag panel for allowing gas in the chest chamber to be discharged from the chest chamber.

5. An airbag apparatus according to claim 1, wherein the head chamber comprises a plurality of compartments to be inflated sequentially.

6. An airbag apparatus according to claim 5, wherein said head chamber comprises first, second and third compartments to be inflated sequentially, said first compartment being inflated first and supporting the second and third compartments, which are inflated with gas flowing from the first compartment, in a position for head protection.

7. An airbag apparatus according to claim 6, wherein said chest chamber is located at a side of the first compartment and under the second and third compartments.

8. An airbag apparatus according to claim 7, wherein the gas supply device is located at a boundary between the first compartment and the chest chamber and supplies more gas into the head chamber than into the chest chamber.
